(19) United States
(12) Patent Application Publication
(10) Pub. No.: US 2025/0088526 A1
(43) Pub. Date: Mar. 13, 2025

(54) SYSTEM AND METHOD FOR COMPUTER NETWORKS ENDPOINT THREAT PREDICTION BASED ON VECTOR EMBEDDING

(71) Applicant: TWEENZNET LTD., Tel Aviv-Yafo (IL)

(72) Inventors: Aviv YEHEZKEL, Ramat-Gan (IL); Eyal ELYASHIV, Ramat Hasharon (IL); Or SOFFER, Tel-Aviv (IL)

(73) Assignee: TWEENZNET LTD., Tel Aviv-Yafo (IL)

(21) Appl. No.: 18/954,681

(22) Filed: Nov. 21, 2024

Related U.S. Application Data
(63) Continuation of application No. 17/947,731, filed on Sep. 19, 2022.
(60) Provisional application No. 63/245,866, filed on Sep. 19, 2021.

(51) Int. Cl. H04L 9/40

(52) U.S. Cl. CPC H04L 63/1425

(57) ABSTRACT

Systems and methods of detecting communication anomalies in a computer network, including: analyzing sampled traffic within the computer network, to identify at least one entity in the computer network, generating a network graph that corresponds to the computer network, wherein the network graph includes a plurality of nodes based on the identified at least one entity, training a deep learning (DL) algorithm to generate at least one vector characterizing the behavior of each entity in the computer network based on the generated network graph, applying the trained DL algorithm on the sampled traffic, to predict the probability of a communication in the sampled traffic, wherein the prediction is based on the generated at least one vector, and detecting an anomaly when the predicted probability is below an anomaly threshold.

### CROSS REFERENCE TO RELATED APPLICATIONS

This application is a Continuation of U.S. patent application Ser. No. 17/947,731, filed on Sep. 19, 2022, which claims the benefit of U.S. Provisional Application No. 63/245,866, filed Sep. 19, 2021, which is incorporated herewith by reference.

### FIELD OF THE INVENTION

The present invention relates to traffic in computer networks. More specifically, the present invention relates to systems and methods for detecting communication anomalies in at least one computer network.

### BACKGROUND

Detecting anomalies in computer networks is a long-term research problem. Computer networks used for data communication can be small household networks such as Wi-Fi networks, or larger networks in the scale of a small-business, city, enterprise, etc. The increase in scale and complexity of “smart networks” poses a seemingly impossible security challenge. Targeted and widespread attacks, and other anomalies can pass through in any one of hundreds or even thousands of network devices (e.g., routers or switches) and can significantly compromise the network security.

The addition of specialized network monitoring and detection solutions to each network device is expensive, and can affect the device's performance. Furthermore, monitoring each component separately is not sufficient. Therefore, detection of sophisticated attacks requires global view and analysis of network patterns between the different devices.

Attacks, threats, and other network anomalies can enter the network through any one of hundreds or even thousands of network devices (e.g., routers, switches, etc.) and can significantly compromise the network security. Adding dedicated network monitoring and detection solutions to each network device is expensive, and can affect the device's performance. Furthermore, monitoring each component separately is not sufficient. Detection of sophisticated cyber-threats requires a global view and analysis of network patterns between the different devices.

Some solutions include analyzing data in the network with a dedicated machine learning (ML) algorithm. However, these algorithms require a complex training process and/or require large processing resources in order to analyze all data for each network device. A common ML approach is to use an anomaly detection algorithm. Such methods can be broadly classified into auto-encoders and hybrid models.

An auto-encoder model is a type of neural network (NN) that is utilized for machine learning in a non-parametric manner. The auto-encoders approach is using the reconstruction error for making anomaly assessments. The aim of the auto-encoder is to learn a representation (or encoding) for a dataset, for instance for dimensionality reduction, by training the NN to ignore signal noise. Along with the reduction side, a reconstructing side is learned (as a decoder), where the autoencoder tries to generate from the reduced encoding a representation as close as possible to its original input. The auto-encoder approach for anomaly detection utilizes the reconstruction error for making anomaly assessments. The hybrid models combine a deep learning detector with an ML classifier, e.g., learning deep features using an auto-encoder and then feeding the features into a separate anomaly detection method such as a one-class support vector machine (SVM).

### SUMMARY OF THE INVENTION

There is thus provided, in accordance with some embodiments of the invention, a method of detecting communication anomalies in a computer network, including: analyzing, by a processor in communication with the computer network, sampled traffic within the computer network, to identify at least one entity in the computer network, generating, by the processor, a network graph that corresponds to the computer network, wherein the network graph includes a plurality of nodes based on the identified at least one entity, training, by the processor, a deep learning (DL) algorithm to generate at least one vector characterizing the behavior of each entity in the computer network based on the generated network graph, applying, by the processor, the trained DL algorithm on the sampled traffic, to predict the probability of a communication in the sampled traffic, wherein the prediction is based on the generated at least one vector, and detecting, by the processor, an anomaly when the predicted probability is below an anomaly threshold.

In some embodiments, the generated network graph includes a graph neural network (GNN) architecture. In some embodiments, the generated at least one vector is clustered to identify groups of related behaving IP addresses in the network. In some embodiments, the DL algorithm includes a link predictor model.

In some embodiments, the DL algorithm is to predict probability of any communication within the computer network. In some embodiments, the generated at least one vector corresponds to at least one of an IP address and a port-protocol-port tuple (PPP). In some embodiments, the network graph is generated based on non-malicious training data of network samples without anomalies. In some embodiments, communication with a network entity associated with the at least one vector is blocked.

There is thus provided, in accordance with some embodiments of the invention, a system for detection of communication anomalies in a computer network, including: a memory, to store a training dataset, and a processor, in communication with the computer network, wherein the processor is configured to: analyze sampled traffic within the computer network, to identify at least one entity in the computer network, generate a network graph that corresponds to the computer network, wherein the network graph includes a plurality of nodes based on the identified at least one entity, train a deep learning (DL) algorithm to generate at least one vector characterizing the behavior of each entity in the computer network based on the generated network graph, and based on the training dataset, apply the trained DL algorithm on the sampled traffic, to predict the probability of a communication in the sampled traffic, wherein the prediction is based on the generated at least one vector, and detect an anomaly when the predicted probability is below an anomaly threshold.

In some embodiments, the generated network graph includes a graph neural network (GNN) architecture. In some embodiments, the processor is configured to cluster the generated at least one vector to identify groups of related behaving IP addresses in the network. In some embodiments, the DL algorithm includes a link predictor model. In some embodiments, the processor is configured to predict probability of any communication within the computer network.

In some embodiments, the generated at least one vector corresponds to at least one of an IP address and a port-protocol-port tuple (PPP). In some embodiments, the network graph is generated based on non-malicious training data of network samples without anomalies. In some embodiments, the processor is configured to block communication with a network entity associated with the at least one vector.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings. Embodiments of the invention are illustrated by way of example and not limitation in the figures of the accompanying drawings, in which like reference numerals indicate corresponding, analogous or similar elements, and in which:

FIG. 1 shows a block diagram of an example computing device, according to some embodiments of the invention;

FIG. 2 shows a schematic block diagram of an anomaly detection system, according to some embodiments of the invention;

FIG. 3 shows a flowchart for network graph generation, according to some embodiments of the invention; and

FIG. 4 shows a flowchart for a method of detecting communication anomalies, according to some embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components, modules, units and/or circuits have not been described in detail so as not to obscure the invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term set when used herein may include one or more items. Unless explicitly stated, the method embodiments described herein are not constrained to a particular order or sequence. Additionally, some of the described method embodiments or elements thereof may occur or be performed simultaneously, at the same point in time, or concurrently.

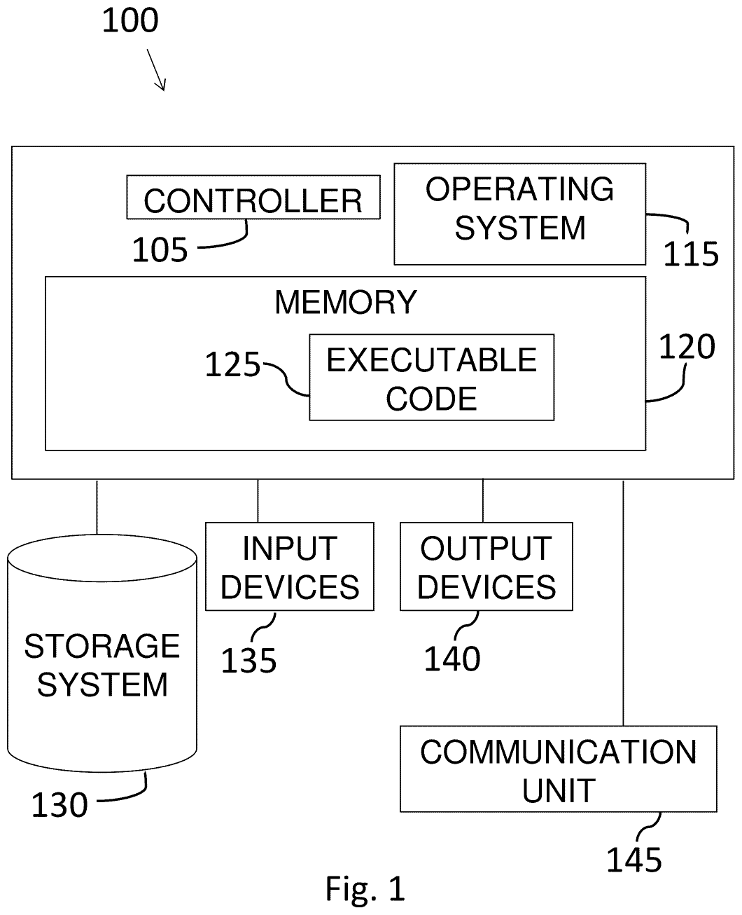

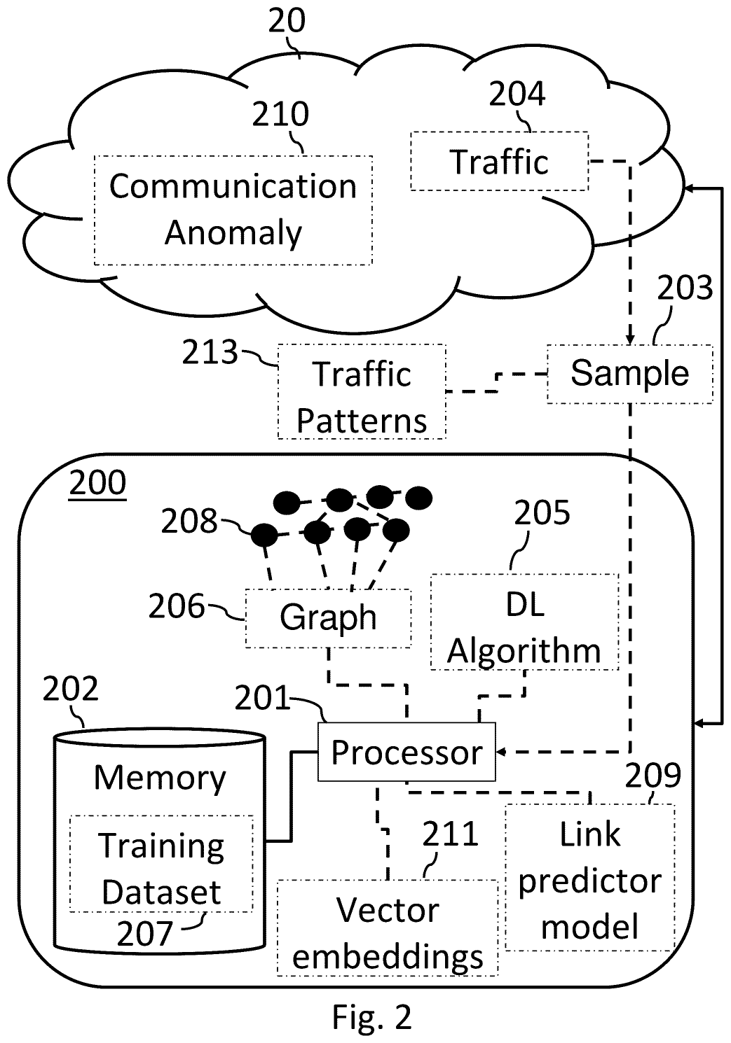

Reference is made to FIG. 1, which is a schematic block diagram of an example computing device, according to some embodiments of the invention. Computing device 100 may include a controller or processor 105 (e.g., a central processing unit processor (CPU), a chip or any suitable computing or computational device), an operating system 115, memory 120, executable code 125, storage 130, input devices 135 (e.g. a keyboard or touchscreen), and output devices 140 (e.g., a display), a communication unit 145 (e.g., a cellular transmitter or modem, a Wi-Fi communication unit, or the like) for communicating with remote devices via a communication network, such as, for example, the Internet. Controller 105 may be configured to execute program code to perform operations described herein. The system described herein may include one or more computing device(s) 100, for example, to act as the various devices or the components shown in FIG. 2. For example, components of system 200 may be, or may include computing device 100 or components thereof.

Operating system 115 may be or may include any code segment (e.g., one similar to executable code 125 described herein) designed and/or configured to perform tasks involving coordinating, scheduling, arbitrating, supervising, controlling or otherwise managing operation of computing device 100, for example, scheduling execution of software programs or enabling software programs or other modules or units to communicate.

Memory 120 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 120 may be or may include a plurality of similar and/or different memory units. Memory 120 may be a computer or processor non-transitory readable medium, or a computer non-transitory storage medium, e.g., a RAM.

Executable code 125 may be any executable code, e.g., an application, a program, a process, task or script. Executable code 125 may be executed by controller 105 possibly under control of operating system 115. For example, executable code 125 may be a software application that performs methods as further described herein. Although, for the sake of clarity, a single item of executable code 125 is shown in FIG. 1, a system according to embodiments of the invention may include a plurality of executable code segments similar to executable code 125 that may be stored into memory 120 and cause controller 105 to carry out methods described herein.

Storage 130 may be or may include, for example, a hard disk drive, a universal serial bus (USB) device or other suitable removable and/or fixed storage unit. In some embodiments, some of the components shown in FIG. 1 may be omitted. For example, memory 120 may be a non-volatile memory having the storage capacity of storage 130. Accordingly, although shown as a separate component, storage 130 may be embedded or included in memory 120.

Input devices 135 may be or may include a keyboard, a touch screen or pad, one or more sensors or any other or additional suitable input device. Any suitable number of input devices 135 may be operatively connected to computing device 100. Output devices 140 may include one or more displays or monitors and/or any other suitable output devices. Any suitable number of output devices 140 may be operatively connected to computing device 100. Any applicable input/output (I/O) devices may be connected to computing device 100 as shown by blocks 135 and 140. For example, a wired or wireless network interface card (NIC), a universal serial bus (USB) device or external hard drive may be included in input devices 135 and/or output devices 140.

Embodiments of the invention may include an article such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein. For example, an article may include a storage medium such as memory 120, computer-executable instructions such as executable code 125 and a controller such as controller 105. Such a non-transitory computer readable medium may be for example a memory, a disk drive, or a USB flash memory, encoding, including or storing instructions, e.g., computer-executable instructions, which when executed by a processor or controller, carry out methods disclosed herein. The storage medium may include, but is not limited to, any type of disk including, semiconductor devices such as read-only memories (ROMs) and/or random-access memories (RAMs), flash memories, electrically erasable programmable read-only memories (EEPROMs) or any type of media suitable for storing electronic instructions, including programmable storage devices. For example, in some embodiments, memory 120 is a non-transitory machine-readable medium.

A system according to embodiments of the invention may include components such as, but not limited to, a plurality of central processing units (CPUs), a plurality of graphics processing units (GPUs), or any other suitable multi-purpose or specific processors or controllers (e.g., controllers similar to controller 105), a plurality of input units, a plurality of output units, a plurality of memory units, and a plurality of storage units. A system may additionally include other suitable hardware components and/or software components. In some embodiments, a system may include or may be, for example, a personal computer, a desktop computer, a laptop computer, a workstation, a server computer, a network device, or any other suitable computing device. For example, a system as described herein may include one or more facility computing device 100 and one or more remote server computers in active communication with one or more facility computing device 100 such as computing device 100, and in active communication with one or more portable or mobile devices such as smartphones, tablets and the like.

Reference is made to FIG. 2, which is a schematic block diagram of an anomaly detection system 200, according to some embodiments of the invention. In FIG. 2, hardware elements are indicated with a solid line and the direction of arrows indicate a direction of information flow between the hardware elements.

The system 200 may include a processor 201 (e.g., such as controller 105, shown in FIG. 1) in communication with a computer network 20. In some embodiments, the processor 201 is configured to sample network traffic 204 of the computer network 20 in order to analyze only a sample 203 of the full network traffic 204 (e.g., a sample of 1% may consist of randomly sampling a 1% of the network traffic 204, for example, by sampling a single packet for every 100 packets).

In addition to lower processing cost, a sampling-based network anomaly detection has many advantages, such as (a) data privacy, as the packet's data payload is not collected, stored or analyzed at any moment; and (b) built-in robustness against sophisticated attacker utilizing machine learning techniques, due to the randomized nature of the sampling.

For example, the processor 201 may be connected to the network 20 (e.g., connected to a dedicated gateway such as a server, firewall or switch) to analyze a random sample of network traffic 204 of the computer network 20. The sampling may be carried out in at least one location of at least one computer network 20. A location may be, e.g., a specific client's network site. For example, the processor 201 may sample traffic 204 at a particular network device of the network 20 such as a router, a switch, a firewall, etc.

According to some embodiments, sampling features that are built-in in network devices may be employed for anomaly detection. The processor 201 may analyze one or more sampling features or protocols of the network 20 in order to derive sample 203 (e.g., sFlow and NetFlow sampling protocols which may be built-in to network devices), such that there is no need for dedicated hardware modifications and/or software modifications in the computer network 20 in order to detect communication anomalies 210.

In some embodiments, a dedicated Deep-Learning (DL) algorithm 205 is employed to infer the required information (e.g., characteristics of data packets flow in the network) from the sampled traffic 203 to learn network traffic patterns 213 in the network endpoint level. For example, a network endpoint may be any network entity with an IP address. The DL algorithm 205 may be trained, in some embodiments, by pre-processing the sample 203 using a link prediction model accompanied with generation of a network traffic graph 206 (e.g., transforming the computer network into a graph neural network (GNN)). Such training may be individually carried out for each computer network.

Graph neural networks (GNNs) are a class of artificial neural networks for processing data that may be represented as graphs. GNNs use pairwise message passing where nodes are defined by their neighbors and connections, such that graph nodes iteratively update their representations by exchanging information with their neighbors. Existing neural network architectures may also be interpreted as GNNs operating on suitably defined graphs. For example, convolutional neural networks, in the context of computer vision, may be seen as a GNN applied to graphs structured as grids of pixels.

Link prediction is generally the problem of predicting the existence of a link between two entities in a network. Graph embedding algorithms may learn an embedding space in which neighboring nodes are represented by vectors so that vector similarity measures may hold in the embedding space. These similarities may be functions of both topological features and attribute-based similarity.

The network (traffic) graph 206 may be heterogenous, and include multiple features of the sampled traffic data 203, represented as nodes 208. In some embodiments, vector representations (or embeddings) are generated for each node of the graph 206, for instance characterizing normal behavior to be later used in model training to detect communication anomalies 210. The vector embedding may be learned for each network graph node 208, by combining different node perspectives, such as node features, and/or node graph connection and/or extracted graph representations.

The network graph 206 may be generated based on key aspects of the network's 20 traffic 204, that are represented as unique nodes 208 and the links between them.

In some embodiments, the DL algorithm 205 may be trained with the link prediction model to assign a probability to each graph node 208 and/or link and detect anomalous links as network communication anomalies 210. For example, the training may be performed based on the learned node embeddings as a vector representation layer, existing graph links as positive samples and/or randomly generated graph links as negative training data.

The DL algorithm may learn the graph's 206 normal behavior (e.g., based on non- malicious data without anomalies) by its' embeddings, similar to Natural Language Processing (NLP) techniques, in order to allow for the use of a link prediction model for an anomaly detection problem. Accordingly, in order to detect a communication anomaly 210, it may be required to predict links in the graph 206, by assigning a probability for communication between two nodes 208 (or more) in the graph 206 to occur.

In some embodiments, the system 200 further includes a memory 202 (e.g., such as memory 120 or storage system 130, shown in FIG. 1) to store a training dataset 207, in order to train the DL algorithm 205, and/or store information regarding the trained data, etc. The DL algorithm 205 may be trained with the training dataset 207 to detect at least one communication anomaly 210 in the computer network 20 based on a network traffic sample data (e.g., determined as an input vector). For example, the training dataset 207 may include vectors with values corresponding to communication patterns in the computer network 20 that are determined to be associated with at least one communication anomaly 210.

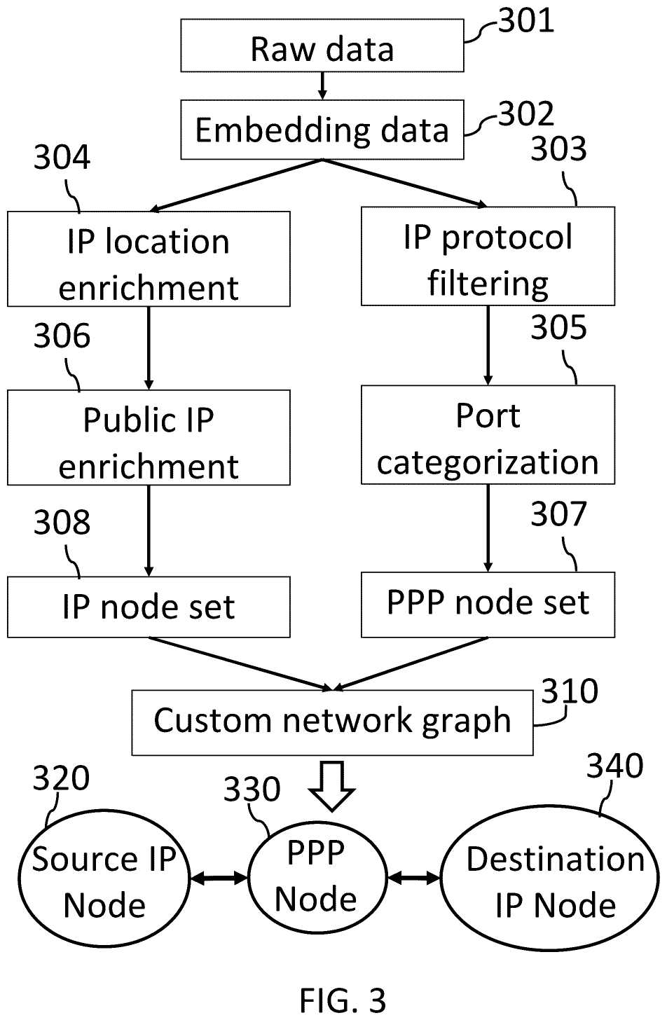

Reference is made to FIG. 3, which shows a flowchart for network graph generation, according to some embodiments of the invention.

In operation 301, the sampled traffic 203 may be received as raw data for processing. For example, sampled flow data may be collected from the network's 20 main gateways (e.g., firewalls and switches). A flow is a set of packets with a shared “network ID”, namely a shared combination of several network fields such as “source IP address” and “destination IP address”. Traffic flows, or sets of packets with a common property, may be defined as several categories in the sample (e.g., flows that are represented with sufficient number of packets in the sample to provide reliable estimate of their frequencies in the total traffic).

Each record or data point in the sampled data 203 may represent a meta-data summarization of communication between two endpoints (each is a network entity with an IP address) in the network 20 with their flow details. Every flow may describe several network connections made in a short timeframe. The flow details may include at least one of: source IP address, destination IP address, source network port, destination network port, IP protocol, creation time, number of packets in flow, and flow length in bytes.

The raw data sample data may be used to build a network graph with different node extraction methods for the IP entities set, and PPP triplets set (e.g., a port-protocol-port tuple). The IP entities set may include different endpoints by their IP address (e.g., the flow's source and destination IPs).

The PPP triplet entities may be an artificial node representing the communication between IP entities, including a combination between the flow's source port, destination port and IP protocol. For example, the triplet may be a triplet such as: (source port, IP protocol, destination port).

Each of these node types, IP entities set and PPP triplets set, may have a specific logic for their extraction from the dataset, considering the significance of different IP addresses and PPPs in the network's 20 traffic 204.

According to some embodiments, the DL algorithm 205 is trained (based on the learned node embeddings as a vector representation layer), to assign a probability to each graph link and to detect anomalous links. In training-time, the data is divided into two consecutive timespans, in order to serve learning node embeddings and training by the DL algorithm 205.

The first consecutive timespan may include embedding data: {X₁^{embed} . . . X_{N}^{embed}} for training graph node vector representations, and link predictor model 209 data: {X₁^{model} . . . X_{N}^{model}} for link predictor model training, with positive labeled data.

In operation 302, only embedding data (X^{embed}) may be processed for generation of the network graph 206 structure with different node extraction methods for each node set type: IP Entity set: {N₁^{IP} . . . N_{N}^{IP}}—network IP entities and PPP triplet set: {N₁^{PPP} . . . N_{N}^{PPP}}—a unique combination set of artifacts [source port, IP protocol, destination port].

In some embodiments, operation 302 may further include data cleaning and/or dataset splitting and/or identification of link predictor data.

Every IP may initially be enriched with its network category, either internal (local endpoint inside the client network), external (a public IP owned by the client network) or public (public internet IP outside the client network).

N₁ may include different network IP entities, where every IP in X^{embed} may be enriched with the property (category) of its network location as internal IP, external IP or a public IP address. This category may be assigned by cross-referencing IP addresses with previously automated internal-external subnet extraction, and with a public IP library repository. In operation 304, IP location enrichment may be performed for the public IPs. Both internal IP and external IP entities may be assigned with their own node IDs.

Public IPs are processed differently, where each public IP entity may further be enriched with its hosting country and organization, by querying an IP enrichment repository. Post enrichment, each [country, organization] unique combination may be assigned with a node ID. Thus, every public IP that shares the same hosting country and organization, may be assigned with the same ID and treated by the network graph 206 as the same entity. This ID assignment may be carried out to reduce the graph dimension and/or improve the model generalization in inference-time for new “unseen” IPs, by ensuring that the same logical communication may not be treated differently because of different raw IP values. For example, in case of x.x.x.x and y.y.y.y as two IP addresses associated with Google™ in the US, and a.b.c.d as an IP of a user browsing into Google™. Despite the different IP addresses, their functionality is the same, and the user may end up communicating with either of them. Thus, the model may treat them similarly.

In operations 306 and 308, IP enrichment may be performed for the public IP and every IP may be assigned with its own node ID, respectively.

N₂ may include unique PPP triplet combinations [source port, IP protocol, destination port], also processed in order to reach better significance when describing the different communication channels between IP entities. The X^{embed} data may be grouped by the IP protocol feature. Flow packet counts may be then aggregated (summed) for each unique IP protocol. In operation 303, according to this aggregation, every IP protocol with a total flow packet count that is lower than a certain threshold of the total flow count (e.g., 0.1% of the total count) may be assigned with a general IP protocol identifier, when assigning PPP node IDs, as opposed to the remaining IP protocols, that may be assigned their own identifier. By assigning the general IP protocol identifier, the potential effect of low-volume protocols may be reduced.

Additional pre-processing may be carried out on the port values. In operation 305, post IP protocol filtering, additional processing is made on port features. Each port feature (source/destination) may be assigned with a category, according to a port range convention by the Internet Assigned Numbers Authority (IANA). Ports in range (0, 1023) are considered system or well-known ports, meaning they posses high significance, and may be assigned with a unique identifier. Ports in range (1024, 49151) are user or registered ports, meaning low feature significance, and may be assigned with a shared “registered ports” identifier. Ports in range (49152, 65535) are dynamic/private/ephemeral ports, meaning low feature significance, and may be assigned with a shared “dynamic ports” identifier.

In operation 307, after both IP protocols and network port artifacts were categorized, every unique [categorized source port, IP protocol, destination port] triplet may be assigned with its own node ID, except specific exclusions in the triplet level. As ICMP IP protocol (“pings”) has no ports associated with it, every triplet that includes the ICMP IP protocol, may be assigned with the same ID, in order to improve model generalization and reduce noise.

In some embodiments, the extracted IP and PPP nodes represent the data's “vocabulary”, in Natural Language Processing (NLP) terms. All assigned node IDs may be mapped in the next stages to all corresponding data point assets. For X^{model} (link predictor training data) may include a graph node that was not present in X^{embed}, for instance for out-of-vocabulary IP entities and/or PPP triplets, and it may be mapped to a general unknown identifier.

In operation 310, the network graph 206 is generated based on the assigned nodes 208. Each connection in the created network graph 206 may include a triple pairing between a source IP node, a PPP node and a destination IP node.

The graph edges may be created to transform each flow of (source IP, PPP, destination IP) to two unidirectional edges: the first is between source IP node 320 to PPP node 330, and the second is between the PPP node 320 to the destination IP node 340. Thus, connection between two IP addresses, as in the original data, may be described by the graph as three nodes, connected in two unidirectional edges: source IP node->PPP node->destination IP node.

Referring now back to FIG. 2. According to some embodiments, the system 200 may provide transformation of the training data 207 from flattened sampled time-series communication meta-data to a cybersecurity-oriented graph. The graph 206 data structure may allow for a different analytic perspective for approaching the anomaly detection problem in this space, and enable leveraging methods from the fields of Natural Language Processing (NLP), like building artifact embeddings, in combination with Graph Neural Networks (GNNs), for learning a network's behavior. As in NLP, the embeddings may be learnt in an unsupervised manner (generating negative samples in addition to sampled positive samples), the embedding layer then may provide a supervised context for the task of link prediction.

In some embodiments, the system 200 may provide use of a graph embedding learning technique, that distills node features, edge (or link to other graph nodes) features and/or graph structure information, in order to build a node vector representation. These embeddings may provide a network context for each of the selected network entities, that may be used for a variety of learning tasks, including the utilization of link prediction for anomaly detection purposes.

Different edge types may be used for training vector embeddings 211 from the network graph 206 in order to account for different network behaviors—e.g., over different parts of the connection (for example, smaller packet sizes when initiating the connection than when sending data) and different times (for example, work-hours may be different than midnight). An average packet volume may be determined to account for different traffic volumes sent over the flow. Thus, multiple (e.g., ten) different edge types may be created by splitting the flow packet count (e.g., splitting to ten equal sized bins).

An additional type may be for time of day. Twenty-four different edge types may be created by splitting the flow by the current time (e.g., per hour). Thus, several node features may be used, creating a vector for each node including at least one of: IP address ID, IP address subnet B (255.255.X.X) ID, IP address subnet C (255.255.255.X) ID, IP address country ID, IP address organization ID, and network location category (internal IP, external interface IP, or public IP address).

In some embodiments, the embeddings may be learned based on the “metapath2vec” algorithm of graph walks. Graph walks may be determined as an additional method for representing the graph structure. Each node may be sampled for random graph walks or paths, starting from the selected node. This process may result in a 200-length vector embedding learned for each node for each one of the 36 extracted graphs (e.g., having 10 packet volume average graphs and 24 hourly graphs). Thus, each graph node may be represented by a (36, 200) matrix. To reach a one-dimensional node representation, the 36 node vectors may be averaged to a single 200-length vector.

Thus, the network graph 206 may be extracted or split by the edge type (e.g., per data packet volume and/or time of the communication). Embedding pre-processing may be applied based on the extracted graph, using node features and graph connections. Graph connections may be determined with each sampled network connection from the original data to be converted to two different graph connections: source IP node->PPP node and/or the PPP node->destination IP node.

The result of the embedding pre-processing may be utilized for graph walk generation (with node graph walks). Embedding learning may be applied based on the graph walks, with node embedding per graph. In some embodiments, node embedding averaging may be carried out with embedding per node.

According to some embodiments, a link predictor model 209 may be trained to detect anomalies based on the trained graph node embeddings. For example, the DL algorithm 205 may include the link predictor model 209.

An anomaly may be detected when a predefined probability threshold is passed for a specific link.

In order to train the link predictor model 209, the products of the previous stages may be utilized. Specifically, the generated node ID assignments (or vocabulary), and the learned node embeddings.

According to some embodiments, after learning the vector embeddings 211 of each network entity, the vectors may be clustered such that similar behaving IP addresses (e.g., servers of the same functionality, like DNS servers) may be grouped together in order to discover groups of similar servers and assets.

A link predictor model 209 may receive a pairing of nodes, representing a graph connection, as input. The purpose of the link predictor model 209 is to predict how probable is this node connection to exist. In some embodiments, each node may be represented in the dataset by a token, extracted in a pre-training tokenization process. During training, each token may be translated to a node embedding, also learned before training.

The link predictor model's 209 training may be based on existing graph connections as positive labeled samples, and a negative sample dataset. A high ratio of negative to positive samples may enable the model to better learn this latent space's behavior and limits.

In some embodiments, the link predictor model 209 may learn a triplet combination (IP node, PPP node, IP node) as its input, instead of the traditional two-node single graph connection. As mentioned before, the triplet represents a single data point of the original data. Thus, the initial dataset may be X^{model}.

The training dataset 207 may include the sampled raw network traffic meta-data. In some embodiments, ID tokenization extracted from X^{embed}, X^{model} may be processed to create X^{model-pos}: as positive labeled tokenized input for the link predictor model 209.

Positive labeled inputs may be sampled from the sampled data, and negative labeled inputs may be generated by pairing random triplets that were not part of the sampled data. In some embodiments, combining the positive and negative datasets forms the input data for the link predictor model 209.

In order to transform X^{model} to X^{model-pos}, the same enrichment and processing methods for generation of the network graph 206 may be applied, except for ID generation (building the vocabulary). For ID tokenization, translating IP/PPP entities to their corresponding graph node IDs, the IDs extracted for X^{embed} may be utilized. Any IP entity or PPP entity that is present in X^{model}, but not present in X^{embed}, may be represented by the “unknown” token. This process may result in a tokenized dataset, X^{model-pos}, describing each network traffic connection originally described in X^{model}, X^{model-pos} positive labels may be inserted to Y^{model-pos}.

After the X^{model-pos} transformation is complete, X^{model-neg} may be generated: as negative labeled tokenized input for the link predictor model 209. The extracted IP node set 308, shown in FIG. 3, and PPP node set 307, shown in FIG. 3, (N^{IP}, N^{PPP}) may be iterated over to generate negative samples per node.

For each node, 250 negative triplets (IP, PPP, IP) may be generated, sampling the additional two nodes from (N^{IP}, N^{PPP}) node sets. For PPP node negative generation, two IP nodes may be randomly sampled from N^{IP}. For IP node negative generation, one IP node may be randomly sampled from N^{IP}, and one IP node may be randomly sampled from N^{PPP}.

Each negative sample may be cross-referenced with the X^{model-pos} dataset, in order to ensure the negativity, in relation to the dataset. In case that a match is found in the positive dataset for a generated negative sample, a new sample may be generated (and again cross-referenced). This iterative process may result in X^{model-neg}. Similarly, X^{model-neg} negative labels may be inserted to Y^{model-neg}.

The union of the model-pos and the model-neg datasets may form the input data for the link predictor model 209. This input may be split randomly to training and validation datasets, denoted as (X^{model-train}, Y^{model-train}) and (X^{LP-val}, Y^{model-train}), with a ratio of 80/20 percent.

The link predictor's model 209 structure may be a feed-forward neural network and include at least one of the following layers: an input embedding layer, and/or a flattening operation, and/or two dense layers, and/or a final output dense layer.

The input embedding layer may include an input size of (3, 200): where each tokenized input node may be translated by this layer to its corresponding learned embedding. The input embedding layer may account for input triplet of (IP, PPP, IP), each embedding of size 200.

The flattening operation may connect the three input node vectors. The two dense layers may include a first dense layer with a larger number of neurons than the second dense layer (e.g., with configuration of (256, 200)).

The final output dense layer may be with the size of 1, including the sigmoid activation function. This layer outputs may include a value in the range of (0, 1), predicting the link's probability.

In some embodiments, layer regularizations and dropouts may be added to prevent training overfitting.

According to some embodiments, model inference may be carried out to determine probability for at least one communication anomaly 210 in the network 20. The model inference may be carried out in real-time using a predetermined probability threshold, detecting network connections beneath the threshold as anomalies 210. The threshold may be learned statistically after the model training (e.g., by taking the 99.99^{th} probabilities' percentile).

Once an anomaly 210 is detected, its root-cause analysis information may be provided from the spotted communication, for instance as the IP->PPP->IP triplet, and a respective message may be displayed to the user or be forwarded to a threat mitigator (e.g., notifying the firewall to block such network connections in the future).

In some embodiments, a different number of layers, sizes and architectures may be used, for example a multiplicative factor may be used to increase the hidden layer size, while keeping the same ratio between layers.

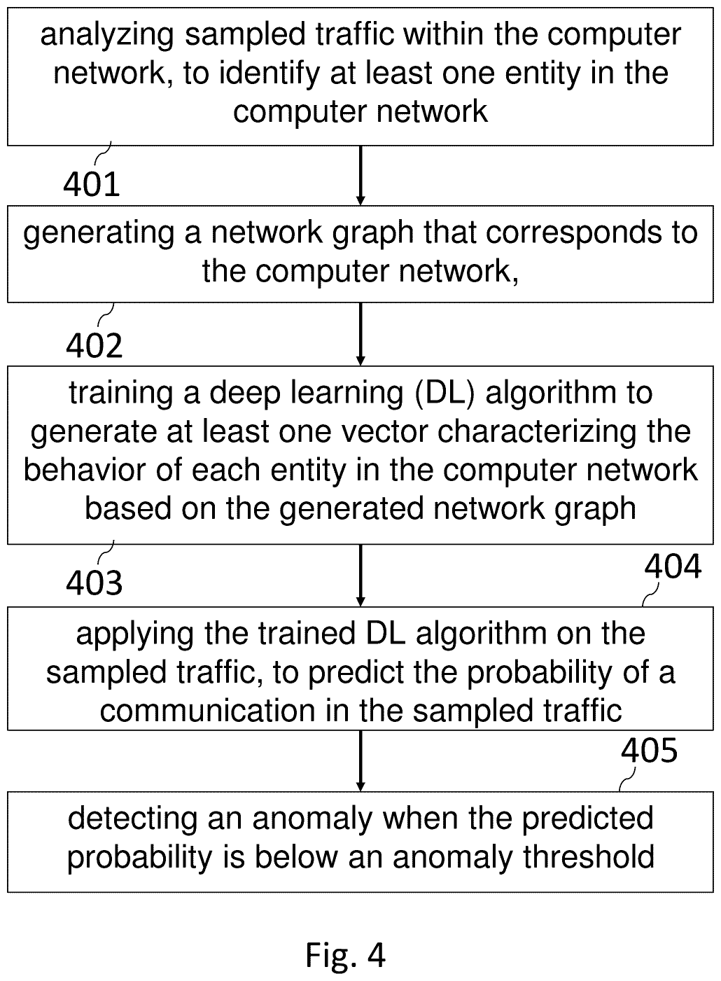

Reference is made to FIG. 4, which shows a flowchart for a method of detecting communication anomalies, according to some embodiments of the invention.

In operation 401, sampled traffic within the computer network, is analyzed to identify at least one entity in the computer network.

In operation 402, a network graph is generated that corresponds to the computer network, wherein the network graph includes a plurality of nodes based on the identified at least one entity.

In operation 403, a DL algorithm is trained to generate at least one vector characterizing the behavior of each entity in the computer network based on the generated network graph.

In operation 404, the trained DL algorithm is applied on the sampled traffic, to predict the probability of a communication in the sampled traffic, wherein the prediction is based on the generated at least one vector.

In operation 405, an anomaly is detected when the predicted probability is below an anomaly threshold.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

Various embodiments have been presented. Each of these embodiments may of course include features from other embodiments presented, and embodiments not specifically described may include various features described herein.

1. A method of detecting communication anomalies in a computer network, the method comprising:
analyzing, by a processor in communication with the computer network, sampled traffic within the computer network, to identify at least one entity in the computer network;
generating, by the processor, a network graph that corresponds to the computer network, wherein the network graph comprises a plurality of nodes based on the identified at least one entity;
training, by the processor, a deep learning (DL) algorithm to generate at least one vector characterizing the behavior of each entity in the computer network based on the generated network graph;
applying, by the processor, the trained DL algorithm on the sampled traffic, to predict the probability of a communication in the sampled traffic, wherein the prediction is based on the generated at least one vector; and
detecting, by the processor, an anomaly when the predicted probability is below an anomaly threshold.

2. The method of claim 1, wherein the generated network graph comprises a graph neural network (GNN) architecture.

3. The method of claim 1, further comprising clustering the generated at least one vector to identify groups of related behaving IP addresses in the network.

4. The method of claim 1, wherein the DL algorithm comprises a link predictor model.

5. The method of claim 1, wherein the DL algorithm is to predict probability of any communication within the computer network.

6. The method of claim 1, wherein the generated at least one vector corresponds to at least one of an IP address and a port-protocol-port tuple (PPP).

7. The method of claim 1, wherein the network graph is generated based on non- malicious training data of network samples without anomalies.

8. The method of claim 1, further comprising blocking communication with a network entity associated with the at least one vector.

9. A system for detection of communication anomalies in a computer network, the system comprising:
a memory, to store a training dataset; and
a processor, in communication with the computer network, wherein the processor is configured to:
analyze sampled traffic within the computer network, to identify at least one entity in the computer network;
generate a network graph that corresponds to the computer network, wherein the network graph comprises a plurality of nodes based on the identified at least one entity;
train a deep learning (DL) algorithm to generate at least one vector characterizing the behavior of each entity in the computer network based on the generated network graph, and based on the training dataset;
apply the trained DL algorithm on the sampled traffic, to predict the probability of a communication in the sampled traffic, wherein the prediction is based on the generated at least one vector; and
detect an anomaly when the predicted probability is below an anomaly threshold.

10. The system of claim 9, wherein the generated network graph comprises a graph neural network (GNN) architecture.

11. The system of claim 9, wherein the processor is configured to cluster the generated at least one vector to identify groups of related behaving IP addresses in the network.

12. The system of claim 9, wherein the DL algorithm comprises a link predictor model.

13. The system of claim 9, wherein the processor is configured to predict probability of any communication within the computer network.

14. The system of claim 9, wherein the generated at least one vector corresponds to at least one of an IP address and a port-protocol-port tuple (PPP).

15. The system of claim 9, wherein the network graph is generated based on non-malicious training data of network samples without anomalies.

16. The system of claim 9, wherein the processor is configured to block communication with a network entity associated with the at least one vector.
